(19) United States
(12) Patent Application Publication
(10) Pub. No.: US 2025/0071730 A1
(43) Pub. Date: Feb. 27, 2025

(54) Enabling Paging Occasions of Idle State for Inactive State

(71) Applicant: Google LLC, Mountain View, CA (US)

(72) Inventors: Chih-Hsiang WU, Taoyuan City (TW); Ching-Jung Hsieh, Taipei City (TW)

(21) Appl. No.: 18/702,976

(22) PCT Filed: Oct. 21, 2022
(86) PCT No.: PCT/US22/47343

§ 371 Date: Apr. 19, 2024

Related U.S. Application Data
(60) Provisional application No. 63/270,147, filed on Oct. 21, 2021.

(51) Int. Cl. H04W 68/02

(52) U.S. Cl. CPC H04W 68/02

(57) ABSTRACT

Network nodes, such as distributed units (DUs) and central units (CUs) of distributed base stations, perform methods for managing paging operations. An example method, performed by a DU. for determining paging occasions includes: receiving (1102), by the DU from the CU, an indication as to whether a user equipment (UE) operating in an inactive state associated with a protocol for controlling radio resources supports determining inactive state paging occasions using a parameter defined for determining idle state paging occasions; determining (1104), by the DU, the inactive state paging occasions based on the indication; and paging (1106), by the DU, the UE operating in the inactive state at the inactive state paging occasions.

### FIELD OF THE DISCLOSURE

This disclosure relates to wireless communications and, more particularly, to managing paging operations for inactive user equipment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures.

In some scenarios, a UE operates in a state in which a radio resource control connection with the RAN is not active (e.g., RRC_IDLE or RRC_INACTIVE state) and subsequently transitions to the connected state. Generally speaking, in the inactive state, the radio connection between the UE and the radio access network (RAN) is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

In some cases, the UE in the RRC_IDLE or RRC_INACTIVE state has only one or some, relatively small packets to transmit, or the base station has only one or some, relatively small packets to transmit to the UE operating in the RRC_IDLE or RRC_INACTIVE state. In these cases, the UE in the RRC_IDLE or RRC_INACTIVE state can perform an early data communication without transitioning to the RRC_CONNECTED state, e.g., by using techniques as specified in section 7.3a-7.3d in 3GPP specification 36.300 v16.4.0.

The UE in the RRC_INACTIVE state monitors for both CN-initiated paging and RAN-initiated paging. 3GPP specification 38.300 v16.7.0, for example, describes how paging occasions (POs) of a UE for CN-initiated and RAN-initiated paging are based on the same UE ID, resulting in overlapping POs for both the CN-initiated and RAN-initiated paging. Therefore, the UE in the RRC_INACTIVE state can monitor for both CN-initiated paging and RAN-initiated paging in the overlapping POs.

To determine a PO, a UE uses a DRX cycle (i.e., parameter T) to determine a PO. However, a DRX cycle for the RRC_INACTIVE state can be different from a DRX cycle for the RRC_IDLE state. Accordingly, a UE using the DRX cycle to calculate a PO would calculate a different PO depending on whether the UE is operating in the RRC_INACTIVE state or the RRC_IDLE state.

To address this PO mismatch, 3GPP has agreed upon a new function. A UE operating in the RRC_INACTIVE state that supports this new function determines a PO using the same parameters (e.g., an index i_s) that the UE would utilize to determine a PO in the RRC_IDLE state.

To configure the UE to utilize this new function, a base station (e.g., gNB or ng-eNB), for example, transmits an RRC release message to the UE to transition the UE from the RRC_CONNECTED state to the RRC_INACTIVE state. If both the UE and base station support the new function (i.e., calculating a PO using, in the inactive state, the same index i_s as in the RRC_IDLE state), the base station includes, in the RRC release message, a useIdlePO configuration to enable the UE to use the new function.

However, it is unclear how a distributed base station including a CU and a DU utilizes the useIdlePO configuration to determine paging occasions for a UE. For example, a DU, which is responsible for paging the UE, may be unaware of whether the UE operating in the inactive state supports determining paging occasions using parameters conventionally used for the idle state.

### SUMMARY

To address challenges with implementing the above-identified function in a distributed base station, a CU can transmit a notification to the DU including an indication as to whether a UE operating in an inactive state (e.g., RRC_INACTIVE) supports determining inactive state paging occasions using parameters used for determining idle state paging occasions. For example, the CU may include such an indication in a paging message that causes the DU to page the DU. After receiving the paging message, the DU can determine paging occasions for a UE operating in the inactive state based on the indication included in the paging message. Thus, if the UE supports determining inactive state paging occasions using parameters used for the idle state, the DU can calculate the inactive state paging occasions using such idle state parameters. Otherwise, the DU can calculate the inactive state paging occasions using parameters defined for determining paging occasions for the inactive state.

Further, in the paging message, the CU may also include a useIdlePO configuration, which the DU can take into account when determining paging occasions for the UE.

One example embodiment is a method, performed by a distributed unit (DU) of a distributed base station including a central unit (CU) and the DU, for determining paging occasions. The method includes: receiving, by the DU from the CU, an indication as to whether a user equipment (UE) operating in an inactive state associated with a protocol for controlling radio resources supports determining inactive state paging occasions using a parameter defined for determining idle state paging occasions; determining, by the DU, the inactive state paging occasions based on the indication; and paging, by the DU, the UE operating in the inactive state at the inactive state paging occasions.

Another example embodiment is a method, performed by a central unit (CU) of a distributed base station including the CU and a distributed unit (DU), for managing paging occasion determination. The method includes: determining, by the CU, to page a user equipment (UE) operating in an inactive state associated with a protocol for controlling radio resources; and transmitting, by the CU to the DU, a paging message to cause the DU to page the UE, the paging message including an indication as to whether the UE operating in the inactive state supports determining inactive state paging occasions using a parameter defined for determining idle state paging occasions.

A further example embodiment is a network node configured to implement any one of the above methods.

### BRIEF DESCRIPTION OF THE DRAWINGS

FIG. 1A is a block diagram of an example wireless communication system in which a Core Network (CN), a base station (BS), and a User Equipment (UE) manage paging for unicast services and Multicast and/or Broadcast Services (MBS), according to various embodiments;

FIG. 1B is a block diagram of an example base station (BS) including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A can communicate with a DU and a CU of a base station;

FIG. 3A illustrates an example scenario in which a BS configures a UE operating in an inactive state to use idle state parameters to determine paging occasions pages the UE for unicast data transmission;

FIG. 3B illustrates an example scenario in which a BS configures a UE operating in an inactive state to use idle state parameters to determine paging occasions and pages the UE for multicast data transmission;

FIG. 3C illustrates an example scenario in which a BS configures the a UE operating in an inactive state to use idle state parameters to determine paging occasions and pages the UE for unicast data transmission involving RAN paging;

FIG. 3D illustrates an example scenario in which a BS configures a UE operating in an inactive state to use idle state parameters to determine paging occasions and pages the UE for multicast data transmission involving RAN paging;

FIG. 4A illustrates an example scenario in which a UE performs an RAN Notification Area (RNA) update and transitions from a last serving BS to a new BS, where the new BS causes the UE to transition back to the inactive state after UE context relocation;

FIG. 4B illustrates an example scenario in which a UE performs an RNA update and transitions from the last serving BS to a new BS, where the last serving BS causes the UE to transition back to the inactive state without UE context relocation;

FIG. 4C illustrates an example scenario in which a UE performs an RNA update and transitions from the last serving BS to a new BS, where the new BS transitions the UE to connected state after UE context relocation;

FIG. 5A is a flow diagram of an example method for transitioning a UE to the inactive state following an RNA update and configuring the UE to use the useIdlePO configuration after the RNA update;

FIG. 5B is a flow diagram of an example method for transitioning a UE to the inactive state following an RNA update and configuring the UE to retain the useIdlePO configuration after the RNA update;

FIG. 5C is a flow diagram of an example method for transitioning a UE to the inactive state following an RNA update and causing the UE to release the useIdlePO configuration after the RNA update;

FIG. 5D is a flow diagram of an example method for transitioning a UE to the inactive state following an RNA update and causing the UE to release the useIdlePO configuration by transmitting a specific indication to the UE after RNA update;

FIG. 5E is a flow diagram of an example method for transitioning a UE to the inactive state following an RNA update and configuring, based on a UE capability, the UE to use a useIdlePO configuration after the RNA update;

FIG. 6 is a flow diagram of an example method for determining, based on a received useIdlePO configuration for a UE, whether to transition the UE to the inactive state or to the connected state after an RNA update;

FIG. 7 is a flow diagram of an example method for determining whether to include a full configuration indication when transitioning a UE back to the inactive state after an RNA update;

FIG. 8 is a flow diagram of an example method for determining paging occasions based on configurations for a UE;

FIG. 9 is a flow diagram of an example method for determining state transitions and paging occasions for a UE based on configurations for a UE;

FIG. 10 is a flow diagram of an example method for transitioning a UE to the inactive state following an RNA update and determining whether to configure the UE to use a useIdlePO configuration based on the capability of a neighbor node;

FIG. 11 is a flow diagram of an example method for determining paging occasions, which can be implemented in a DU; and

FIG. 12 is a flow diagram of an example method for managing paging occasion determination, which can be implemented in a CU.

### DETAILED DESCRIPTION OF THE DRAWINGS

Generally speaking, one or more nodes of a wireless communication system (e.g., a CN, base station, RAN node, CU, and/or DU) implement the techniques of this disclosure to manage paging of UEs for multicast and/or broadcast services (MBS) and, in some scenarios, in concert with managing paging of UEs for unicast services.

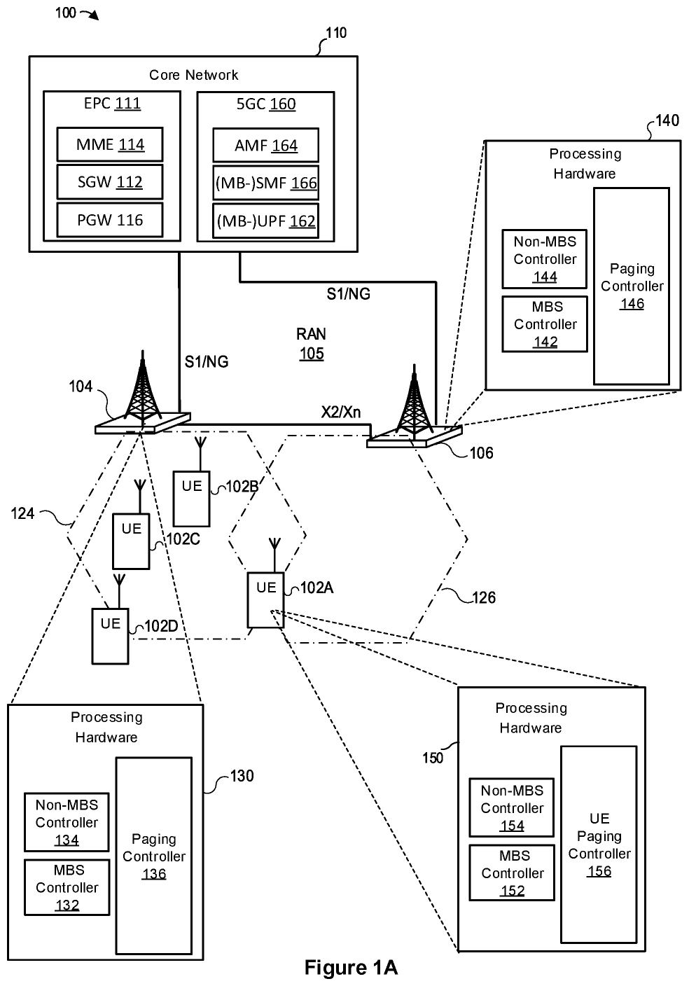

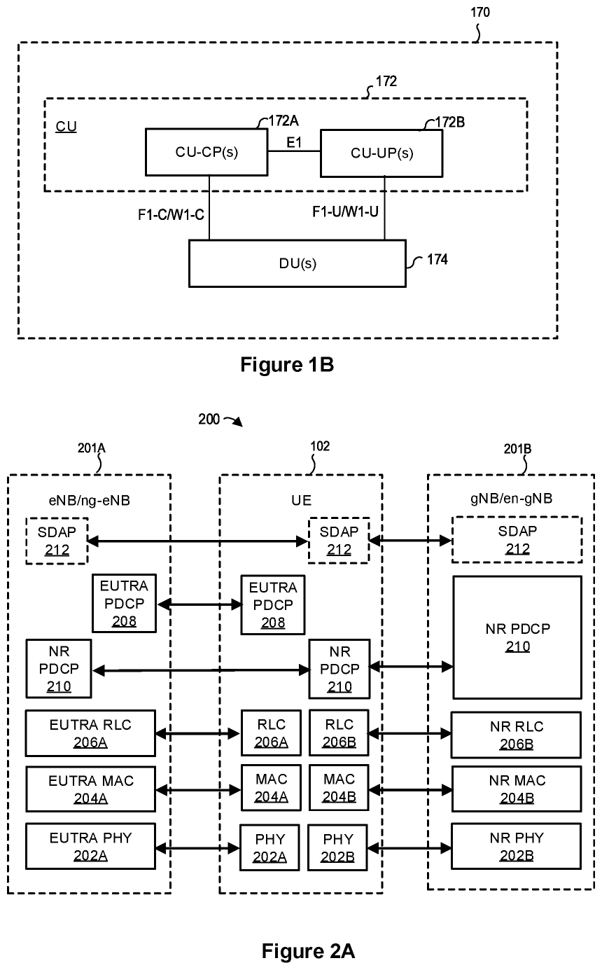

FIG. 1A depicts an example wireless communication system 100 in which techniques for managing paging for unicast services and multicast and/or broadcast services (MBS) information can be implemented. The wireless communication system 100 includes user equipment (UEs) 102A, 102B, 102C, 102D (where UE 102 may refer to the UE 102A, 102B, 102C, and/or 102D) as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation. Further, the processing hardware 130 in an example implementation includes one or more paging controllers 136 configured to manage MBS and non-MBS (e.g., unicast services) paging operations with one or more UEs operating in the RRC_INACTIVE or RRC_IDLE state.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142, a non-MBS controller 144, and one or more paging controllers 146, which may be similar to the controllers 132, 134, 136, respectively, of base station 130. Although not shown in FIG. 1A, the RAN 105 can include additional base stations with processing hardware similar to the processing hardware 130 of the base station 104 and/or the processing hardware 140 of the base station 106. The base stations 104, 106 also include hardware for wirelessly communicating with other devices, including the UE 102A, such as an antenna, transceiver, emitter, and/or receiver.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Further, the processing hardware 150 in an example implementation includes one or more paging controllers 156 configured to manage MBS and non-MBS (e.g., unicast services) paging operations with one or more base stations (e.g., BS 104. 106) when the UE 102A is operating in the RRC_INACTIVE or RRC_IDLE state. Although not shown in FIG. 1A, the UEs 102B, 102C, 102D may include processing hardware similar to the processing hardware 150 of the UE 102A. The UE 102A also includes hardware for wirelessly communicating with other devices, including the RAN 105, such as an antenna, transceiver, emitter, and/or receiver.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112. a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques described herein can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of a base station 170, which may be the base station 104 or 106. In this implementation, the base station 170 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

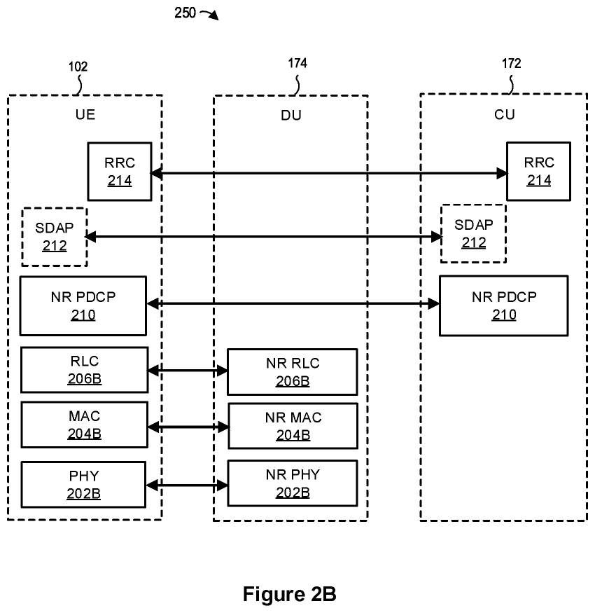

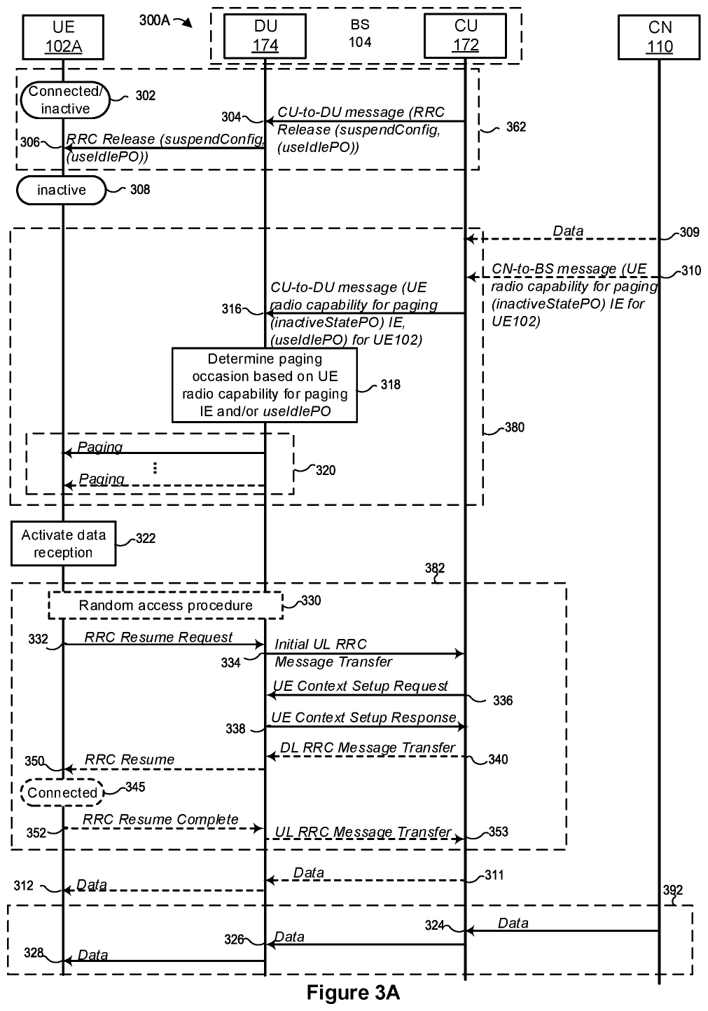

FIG. 2A illustrates, in a simplified manner, an example protocol stack 200 according to which a UE 102 (e.g., UE 102A, 102B, 102C, or 102D) can communicate with an eNB/ng-eNB 201A or a gNB 201B (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202, MAC sublayer 204, and RLC sublayer 206 to receive the MBS data packets. In such implementations, the base station and the UE 102A may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A uses PHY sublayer 202, MAC sublayer 204, RLC sublayer 206 and PDCP sublayer 208 to receive the MBS data packets. In such implementations, the base station and the UE 102A may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250, which a UE 102 (e.g., UE 102A, 102B, 102C, or 102D) can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

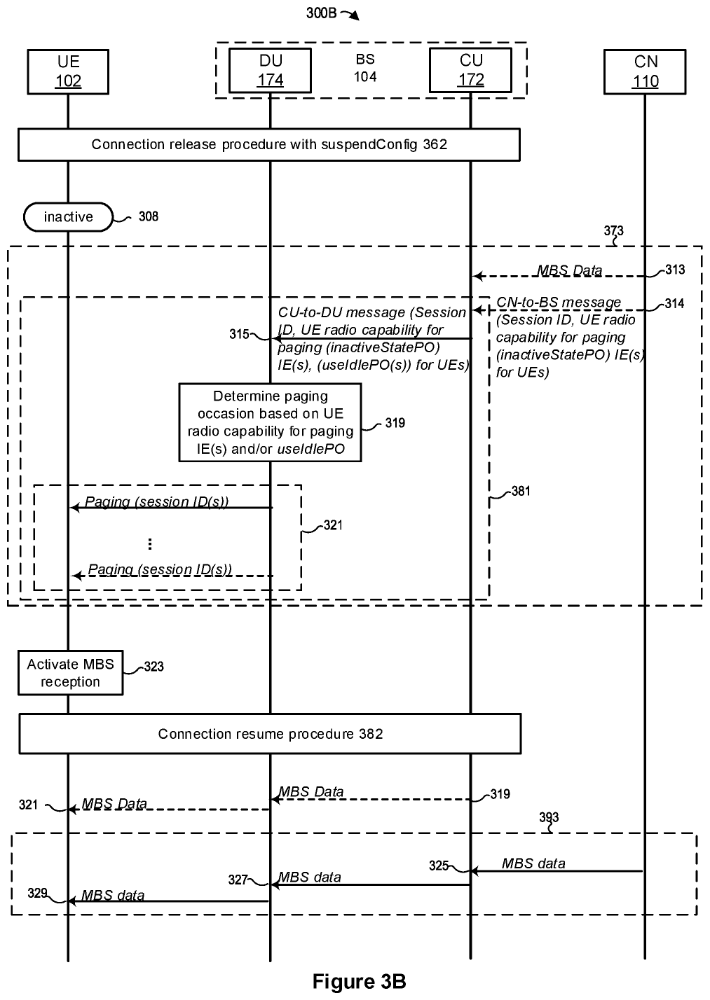

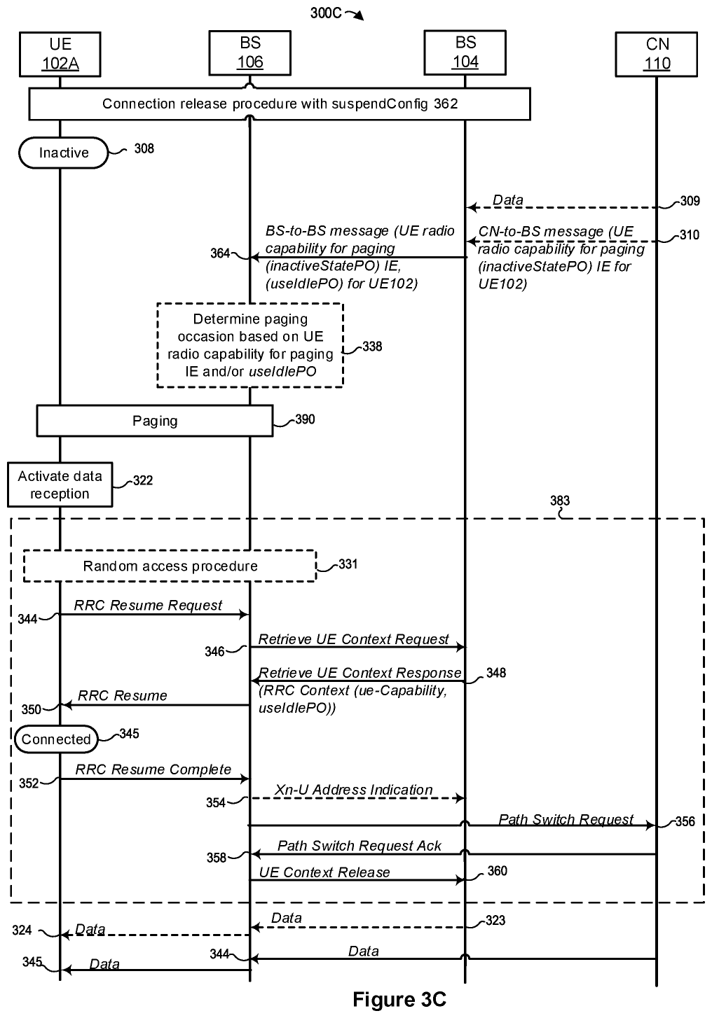

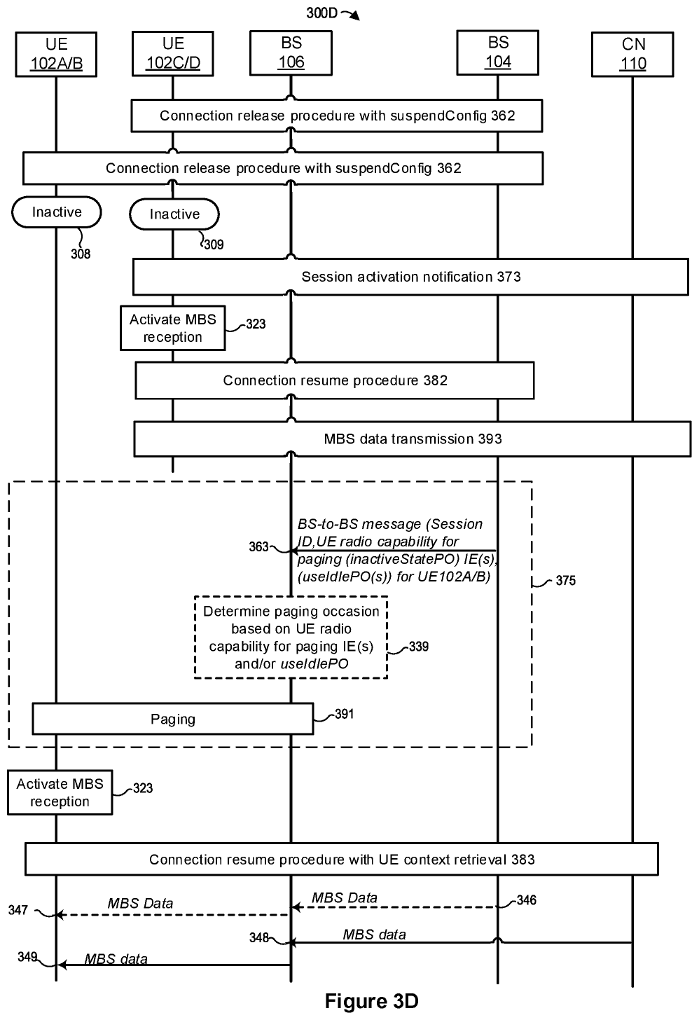

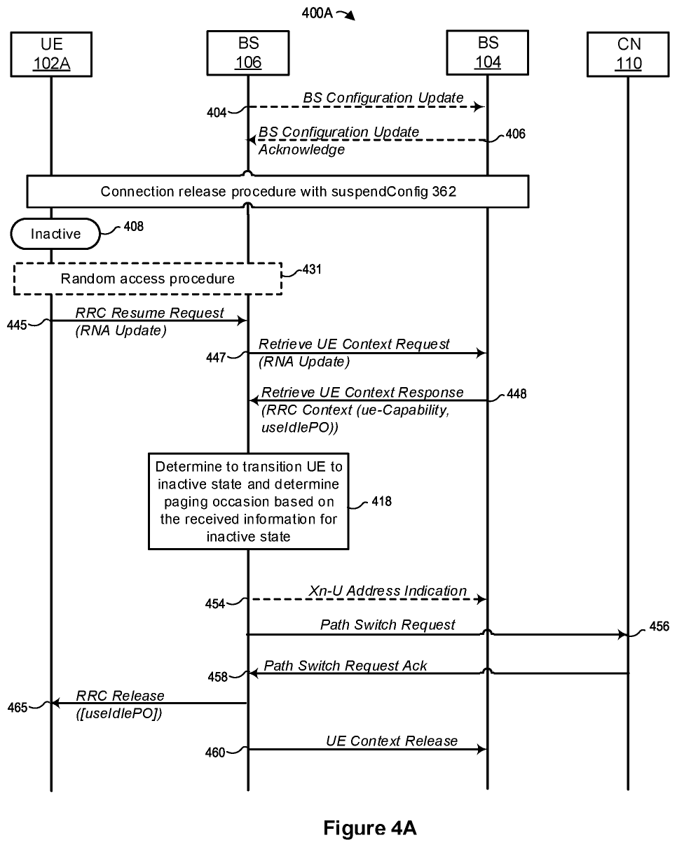

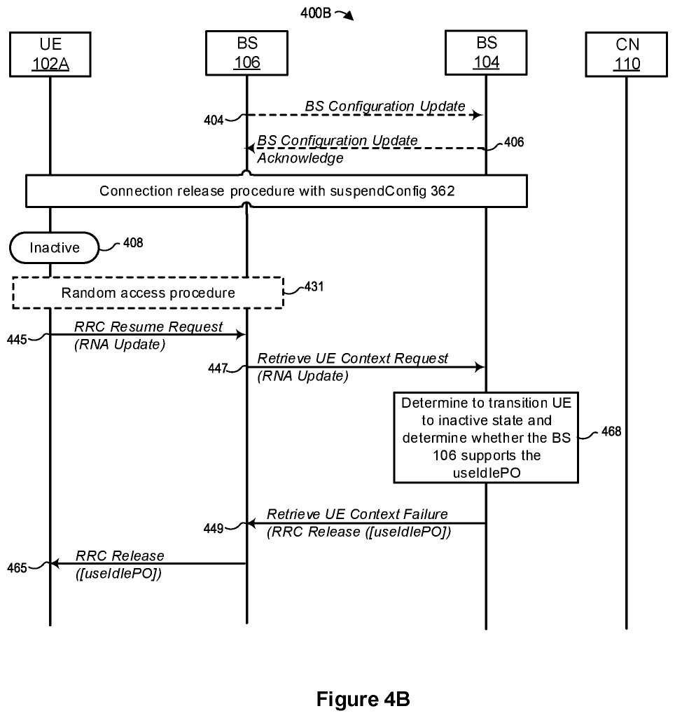

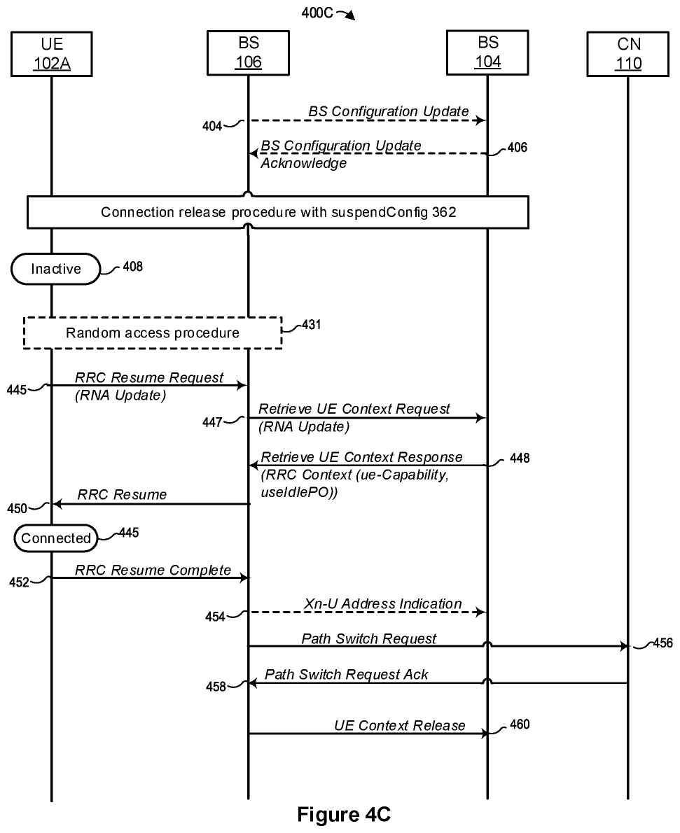

Next, several example scenarios in which a UE and/or a RAN perform methods for supporting paging occasion determination are discussed with reference to FIGS. 3A-3D and 4A-4C. Generally speaking, similar events in FIGS. 3A-3D and 4A-4C are labeled with the same reference numbers, with differences discussed below where appropriate. In the following description, the connected state, inactive state and idle state can be RRC_CONNECTED state, RRC_INACTIVE state and RRC_IDLE state, respectively, for example.

Referring first to FIG. 3A, in a scenario 300A, a base station (BS) 104, including a CU 172 and a DU 174 and/or other DU(s) (not shown in FIG. 3A), transmits to a UE 102A an RRC release message to transition the UE 102A to an inactive state and later pages the UE 102A in accordance with paging occasions (POs) determined by the base station 104. The UE 102A monitors paging on the same determined POs based on a useIdlePO configuration received in the RRC release message.

In the scenario 300A, initially the UE 102A operates 302 either in the connected state in accordance with a configuration or the inactive state in accordance with a configuration of suspension. The CU 172 transmits 304, to the DU 174, a CU-to-DU interface message including an RRC release message (e.g., RRCRelease message defined in 3GPP TS 38.331 or RRCConnectionRelease message defined in 3GPP TS 36.331), which further includes a suspend configuration (e.g., suspendConfig) and/or a useIdlePO configuration. In turn, the DU 174 transmits 306 the RRC release message to the UE 102A. In some implementations, if included in the RRC release message, the useIdlePO configuration is located in a container IE (e.g., suspendConfig or cellReselectionPriorities) in the RRC release message. The useIdlePO configuration enables the UE 102A to use parameters for the idle state to calculate paging occasions while the UE operates in the inactive state. In other implementations, if included in the RRC release message, the useIdlePO configuration is not located in the container IE. In response to the CU-to-DU interface message, in some implementations, the DU 174 transmits a DU-to-CU interface message to the CU 172. In some implementations, the CU-to-DU interface message that the CU transmits 304 can be a UE CONTEXT RELEASE COMMAND message or a DL RRC MESSAGE TRANSFER message and the DU-to-CU interface message can be a UE CONTEXT RELEASE COMPLETE message, as defined in 3GPP TS 38.473 or 37.473.

The events 302, 304, and 306 can be collectively referred to as a connection release procedure with suspendConfig 362. The UE then transitions 308 to the inactive state.

In some scenarios and implementations, the CU 172 receives 309 data (e.g., MBS data, unicast service data, such as an Internet Protocol (IP) packet, Ethernet packet) for the UE 102A from the CN 110. In response to receiving 309 the data, the CU 172 transmits 316 a CU-to-DU interface message including the useIdlePO configuration and/or a UE radio capability for paging IE for the UE 102A. The UE radio capability for paging IE may include the inactiveStatePODetermination indication (inactiveStatePO). The inactiveStatePODetermination indication, if included, indicates that the UE 102A operating in an inactive state supports using the parameters for the idle state to determine paging occasions for the inactive state. For example, the inactiveStatePODetermination may have a value “supported.” The CU 172 may additionally include a UE-specific DRX cycle configuration for the UE 102A in the CU-to-DU interface message. In some implementations, the CU 172 receives an NGAP message including the UE radio capability for paging IE from the CN 110, e.g., while the UE 102A operates 302 in the connected state or inactive state. For example, the NGAP message can be an INITIAL CONTEXT SETUP REQUEST message, a UE CONTEXT MODIFICATION REQUEST message, a HANDOVER REQUEST message, or a PATH SWITCH REQUEST ACKNOWLEDGE message. In other implementations, the CU 172 can receive an XnAP message including the UE radio capability for paging IE from BS 106 or a CU of the BS 106, e.g., while the UE 102A operates 302 in the connected state or inactive state. For example, the XnAP message can be a HANDOVER REQUEST message, a RETRIEVE UE CONTEXT RESPONSE message, or a RAN PAGING message. In yet other implementations, the CU 172 can generate the UE radio capability for paging IE from a UE Capability IE (e.g., UE-NR-Capability IE or UE-EUTRA-Capability IE) of the UE 102A, e.g., while the UE 102A operates 302 in the connected state or inactive state. For example, the CU 172 can receive a UECapabilityInformation message including the UE Capability IE from the UE 102A. In another example, the CU 172 can receive the UE Capability IE in the XnAP message from the base station 106. In yet another example, the CU 172 can receive the UE Capability IE in the NGAP message from the CN 110.

In some implementations, the UE radio capability for paging IE can be a UERadioPagingInformation IE defined in TS 38.331 or TS 36.331. In some implementations, the UE radio capability for paging IE includes information of supported NR bands (e.g., supportedBandListNRforPaging IE), an indication of supporting wake-up signal, an indication of supporting paging early indication, and/or information of supported downlink scheduling offset(s) for one or more types and one or more frequency ranges. For example, the information of downlink scheduling offset includes dl-SchedulingOffset-PDSCH-TypeA-FDD-FR1, dl-SchedulingOffset-PDSCH-TypeA-TDD-FR1, dl-SchedulingOffset-PDSCH-TypeA-TDD-FR2, dl-SchedulingOffset-PDSCH-TypeB-FDD-FR1, dl-SchedulingOffset-PDSCH-TypeB-TDD-FR1, and/or dl-SchedulingOffset-PDSCH-TypeB-TDD-FR2.

Alternatively, instead of receiving the data 309, the CU 172 may receive 310, from the CN 110, a CN-to-BS interface message including the UE radio capability for paging IE. In some implementations, the CN-to-BS interface message is a NGAP PAGING message defined in 3GPP TS 38.413. In such cases, the CU 172 can include the received UE radio capability for paging IE in the CU-to-DU interface message that the CU 172 transmits 316.

In some implementations, the CU-to-DU interface message that the CU 172 transmits 316 is a F1 AP PAGING message defined in 3GPP TS 38.473. In other implementations, the CU-to-DU interface message that the CU 172 transmits 316 is a W1AP PAGING message defined in 3GPP TS 37.473.

After receiving 316 the CU-to-DU interface message, the DU 174 determines 318 paging occasions for the UE 102A based on the received UE radio capability for paging IE, the useIdlePO configuration and/or the UE-specific DRX cycle configuration. In some implementations, the DU 174 determines (first) paging occasions for the UE 102A according to parameters used for the idle state in response to receiving the useIdlePO configuration. The DU 174 transmits 320 one or more paging message(s) (e.g., Paging message defined in 3GPP TS 38.331 or 36.331) to the UE 102A within/on the (first) paging occasions. In such cases, the UE 102A determines the same paging occasions according to the parameters used for the idle state in response to receiving the useIdlePO configuration.

In some implementations, in cases where the useIdlePO configuration is absent, the DU 174 calculates (second) paging occasions for the UE 102A using parameters for the inactive state. In such cases, the DU 174 transmits 320 one or more paging message(s) (e.g., Paging message defined in 3GPP TS 38.331 or 36.331) to the UE 102A within/on the (second) paging occasions. The UE 102A also determines the same paging occasions according to the parameters used for the inactive state in response to or because the useIdlePO configuration is absent.

The events 316, 318, and 320 can be collectively referred to as a session activation notification procedure 380.

In response to the paging message that the UE 102A receives 320, the UE 102A activates 322 data reception. In response to activating 322 data reception or receiving 320 the paging message, the UE 102A can perform 330 a random access procedure and/or an RRC resume procedure with the DU 174. In the RRC resume procedure, the UE 102A transmits 332 an RRC resume request message (e.g., RRCResumeRequest message or RRCConnectionResumeRequest message) to the DU 174. The DU 174 transmits 334 an INITIAL UL RRC MESSAGE TRANSFER message including the RRC resume request message to the CU 172. The CU 172 transmits 336 a UE CONTEXT SETUP REQUEST message to the DU 174. The DU 174 in response transmits 338 a UE CONTEXT SETUP RESPONSE message to the CU 172. The CU 172 generates an RRC resume message (e.g., RRCResume message or RRCConnectionResume message) and transmits 340 a DL RRC MESSAGE TRANSFER message including the RRC resume message to the DU 174. The DU 174 transmits 350 the RRC resume message to the UE 102A. In response to receiving the RRC resume message, the UE 102A transitions 345 to the connected state and transmits 352 an RRC resume complete message (e.g., RRCResumeComplete message or RRCConnectionResumeComplete message) to the DU 174. The DU 174 forwards 353 the RRC resume complete message in a UL RRC MESSAGE TRANSFER message to the CU 172.

The events 330, 332, 334, 336, 338, 340, 350, 345, 352, and 353 can be collectively referred to as a connection resume procedure 382.

In the case of receiving 310 the data, the CU 172 transmits 311 the data to the DU 174 and in turn the DU 174 transmits 312 the data to the UE 102A. The CN 110 transmits 324 (subsequent) data to the CU 172, which in turn transmits 326 the (subsequent) data to DU 174. The DU 174 then transmits 328 the (subsequent) data to UE 102A. The events 324, 326, and 328 can be collectively referred to as data transmission 392.

In some scenarios and implementations, the DU 174 can include a small data transmission indication in the paging message(s). In such cases, the CU 172 refrains from transmitting the RRC resume message in response to or after receiving the RRC resume request message, and the events 340, 350, and 345 can be omitted. Thus, the UE 102A remains in the inactive state and receives 312 the data from the DU 174. In the case of the CN 110 sending 324 the subsequent data, the UE 102A operating in the inactive state receives 328 the subsequent data from the DU 174.

In some implementations, the UE 102A and DU 174 can determines the POs and paging frame (PF) in accordance with the following formula and parameters:

SFN for the PF is determined by: (SFN+PF_offset)mod T=(T div N)*(UE_ID mod N).

Index (i_s), indicating the index of the PO is determined by: i_s=floor(UE_ID/N)mod Ns.

T: the DRX cycle configuration of the UE 102A (T is determined by the shortest of the UE-specific DRX value(s) in the UE-specific DRX configuration, if configured by RRC and/or upper layers, and a default DRX value broadcast in system information. In the idle state, if the UE-specific DRX cycle configuration is not configured by upper layers, the default value is applied). N: number of total paging frames in T (configured by nAndPaging FrameOffset with value T, T/2, T/4, T/8, or T/16).

Referring next to FIG. 3B, a scenario 300B is similar to the scenario 300A. However, in the scenario 300B, the CN 110 requests the BS 104 to page UEs that had previously indicated an interest in a particular Multicast and/or Broadcast Service (MBS) and the CU 172 receives from the CN 110 an MBS data or a CN-to-BS interface message for MBS instead of a unicast data. The differences between the scenarios of FIG. 3B and FIG. 3A are discussed below.

In scenario 300B, the UE 102 (e.g., the UE 102A, UE 102B, UE 102C and/or UE 102D), the DU 174, and the CU 172 initially perform 362 a connection release procedure with suspendConfig. The UE 102 transitions 308 to the inactive state. Later in time, the CN 110, BS 104, and UE 102 perform an MBS session activation procedure 373 via which the BS 104 (and specifically, the DU 174 of the BS 104) pages the UE 102A (and, in some cases, other interested UEs operating in the idle or inactive state, e.g., UE 102B, 102C and/or 102D) for the MBS service, and the UE 102 activates 323 reception of MBS content data.

After the UE 102 transitions 308 to the inactive state, the CU 172 can receive 314, from the CN 110, a CN-to-BS interface message, where the message is a single (e.g., one and only one) message that includes multicast or group paging instructions for a set of one or more (but typically multiple or a group of) UEs that are interested in the MBS service (e.g., UE 102A, 102B, 102C and/or 102C) and operating in an idle or inactive state, and that are to be paged for the MBS service. Such a message sent at the event 314 is generally referred to within this document as a “group paging message” or a “multicast paging message.” The CN-to-BS interface message that the CN 110 transmits 314 can include an MBS Session ID, and/or an indication of the identities of UEs that have previously indicated an interest in the MBS service including the UE 102, and/or respective UE radio capability for paging IE(s), which may respectively include an inactiveStatePODetermination indication for UE(s) including the UE 102, and/or respective UE-specific DRX for UE(s) including the UE 102. In some implementations, the CN-to-BS interface message is a MULTICAST GROUP PAGING message defined for 3GPP TS 38.413.

Alternatively, after the UE 102 transitions 308 to the inactive state, the CU 172 may receive 313 MBS data (e.g., an IP packet or Ethernet packet) from the CN 110, similar to the event 309. In such cases, the CU 172 can obtain the useIdlePO configuration(s), the UE radio capability for paging IE(s) and/or the UE-specific DRX cycle configuration, for the UE 102 as described above.

In response to receiving 313 the MBS data or 314 the CN-to-BS message, the CU 172 transmits 315 a CU-to-DU interface message including the MBS Session ID, and/or the indication of the identities of UEs that have previously indicated an interest in the MBS service, and/or the respective UE radio capability for paging IE(s), which may respectively include an inactiveStatePODetermination indication for UE(s) including the UE 102, and/or respective useIdlePO configuration(s) for UE(s) including the UE 102, and/or respective UE-specific DRX for UE(s) including the UE 102. In some implementations, the CU-to-DU interface message is also a multicast paging message and may be a F1 AP PAGING message defined for 3GPP TS 38.473 or a new F1AP MULTICAST GROUP PAGING message.

In some situations, such as when at least some of the UE radio capability for paging IE(s) have been previously stored at the CU 172 and/or at the DU 174, (and as this document discusses elsewhere with respect to other example scenarios), UE radio capability for paging IE(s) can be excluded from the multicast paging message sent by the CN 110 at event 314 or by the CU 172 at event 315.

After receiving 315 the CU-to-DU interface message, the DU 174 determines 319 paging occasions for UE(s) including the UE 102 based on the received respective UE radio capability for paging IE(s), the respective useIdlePO configuration(s), and/or the respective UE-specific DRX(s). In some implementations, the DU 174 determines (first) paging occasions for the UE(s) including the UE 102 according to parameters used for the idle state in response to receiving the respective useIdlePO configuration for the UE(s) including the UE 102. The DU 174 transmits 321 one or more paging message(s) (e.g., Paging message defined in 3GPP TS 38.331 or 36.331) including the MBS Session ID to the UE(s) including the UE 102 within/on the (first) paging occasions. In such cases, the UE 102 determines the same paging occasions according to the parameters used for the idle state in response to receiving the useIdlePO configuration.

In some implementations, in cases where the useIdlePO configuration is absent for UE(s) including the UE 102, the DU 174 calculates (second) paging occasions for the UE(s) including the UE 102 using parameters for the inactive state. In such cases, the DU 174 transmits 320 one or more paging message(s) (e.g., Paging message defined in 3GPP TS 38.331 or 36.331) including the MBS Session ID(s) to the UE(s) including the UE 102 within/on the (second) paging occasions. The UE 102 also determines the same paging occasions according to the parameters used for the inactive state in response to or because of the useIdlePO configuration is absent.

The events 313/314, 315, 319, and 321 can be collectively referred to as a session activation notification procedure 373. The event 315, 319, 321 can be collectively referred to as a RAN session activation notification procedure 381 for a CU-DU-split base station. The UE 102 thereby activates 323 MBS data reception.

The UE 102 performs 382 a connection resume procedure with the base station 104. The CU 172 may transmit 319 the MBS data to the DU 174 if it was received in event 313 and the DU 174 transmits 321 the MBS data to the UE(s) including the UE 102. The CN 110 transmits 325 MBS data to the CU 172 and the CU 172 transmits 327 the MBS data to the DU 174. The DU 174 further transmits 329 the MBS data to the UE(s) including the UE 102. The events 325, 327, and 329 can be collectively referred to as MBS data transmission 393.

Turning to FIG. 3C, in the scenario 300C, the scenario involves an XnAP RAN paging procedure. The UE 102A is initially located in the cell coverage of the BS 104, and the BS 104, the last-serving base station, transitions the UE 102A to the inactive state, as described in scenarios 300A and 300B. The UE 102A then moves from the cell coverage of the BS 104 to the cell coverage of BS 106 while operating in the inactive state. The differences between the scenarios of FIG. 3C and FIGS. 3A and 3B are discussed below.

Initially, the UE 102A performs 362 a connection release procedure with suspendConfig with the BS 104 as described in scenario 300A. The UE 102A transitions 308 to the inactive state. Later in time, the UE 102A moves into the cell coverage of the BS 106 and out of the cell coverage of BS 104.

Similar to scenario 300A, the CN 110 may transmit, to the BS 104, 309 data or 310 a CN-to-BS interface message including a UE radio capability for paging IE, which may include the inactiveStatePODetermination indication for the UE 102A. The BS 104 may perform session activation procedure 380 in its cell coverage as described in scenario 300A. but may not reach the UE 102A as it moves out of its cell coverage. The BS 104 transmits 364, to the BS 106, one of the base stations in the configured RAN Notification Area, a BS-to-BS interface message including the UE capability for paging IE, which may include an inactiveStatePODetermination indication, and/or a useIdlePO configuration, and/or a UE-specific DRX for the UE 102A. In some implementations, the BS-to-BS interface message is a RAN PAGING message as defined in 3GPP TS 38.423.

If the BS 106 is an aggregated base station (i.e., no CU-DU split), the BS 106 determines 338 paging occasions based on the received UE radio capability for paging IE, the useIdlePO configuration, and/or the UE-specific DRX for the UE 102A. In some implementations, the BS 106 determines (first) paging occasions for the UE 102A according to parameters used for the idle state in response to receiving the useIdlePO configuration. The BS 106 transmits 390 one or more paging message(s) (e.g., Paging message defined in 3GPP TS 38.331 or 36.331) to the UE 102A within/on the (first) paging occasions. In such cases, the UE 102A determines the same paging occasions according to the parameters used for the idle state in response to receiving the useIdlePO configuration.

In some implementations, in cases where the useIdlePO configuration is absent, the BS 106 calculates (second) paging occasions for the UE 102A using parameters for the inactive state. In such cases, the BS 106 transmits 390 one or more paging message(s) (e.g., Paging message defined in 3GPP TS 38.331 or 36.331) to the UE 102A within/on the (second) paging occasions. The UE 102A also determines the same paging occasions according to the parameters used for the inactive state in response to or because of the useIdlePO configuration is absent.

In cases where the BS 106 has a CU-DU split architecture, the determination of paging occasions and transmissions of paging messages is similar to event 380 the session activation notification procedure for the UE 102A and CU/DU of BS 106.

The UE 102A thereby activates 322 data reception. The UE 102A may perform 311 random access procedure with the BS 106. The UE 102A transmits 344 an RRC resume request message to the BS 106 including an I-RNTI. The BS 106 transmits 346 a RETRIEVE UE CONTEXT REQUEST message to the BS 104 by resolving the gNB identity contained in the I-RNTI. The BS 104 in response transmits 348 a RETRIEVE UE CONTEXT RESPONSE message including an RRC Context container (e.g., HandoverPreparationInformation message as defined in 3GPP TS 38.331), which may include the UE capability (e.g., ue-CapabilityRAT-List, and/or UE radio capability for paging, which may include an inactiveStatePODetermination indication) and/or the useIdlePO configuration. The BS 106 transmits 350 an RRC resume message to the UE 102A. The UE 102A transitions 345 to the connected state. The UE transmits 352 an RRC resume complete message to the BS 106. The BS 106 may transmit 354 an Xn-U ADDRESS INDICATION message for data forwarding to the BS 104. The BS 106 transmits 356 a PATH SWITCH REQUEST message to the CN 110. The CN 110 in response transmits 358 a RETRIEVE UE CONTEXT REQUEST ACKNOWLEDGE message to the BS 106. The BS 106 transmits 360 a UE CONTEXT RELEASE message to the BS 104. The events 331, 344, 346, 348, 350, 345, 352, 354, 356, 358, 360 can be collectively referred to as a connection resume procedure with a UE context retrieval 383. If received in event 310, the BS 104 may forward 323 the data to the BS 106 and the BS 106 transmits 324 the data to the UE 102A. The CN 110 transmits 344 data to the BS 106 and the BS 106 transmits 345 the data to the UE 102A.

Now referring to FIG. 3D, a scenario 300D is similar to the scenarios 300A, 300B and 300C and includes MBS paging and UE context retrieval. The scenario also involves an XnAP RAN paging procedure as the UE 102A and UE 102B move to the cell coverage of BS 106 from the cell coverage of the BS 104, as described in scenario 300A and 300B. The differences between the scenarios of FIG. 3D and FIGS. 3A, 3B and 3C are discussed below.

Initially, the UE 102A, 102B, 102C, 102D are in the cell coverage of BS 104. The UE 102C and 102D perform 362 connection release procedure with suspendConfig with the BS 104. The UE 102A and 102B also perform 362 connection release procedure with suspendConfig with the BS 104. The UE 102A, 102B, 102C, 102D transition 308, 309 to the inactive state. Later in time, the UE 102A and 102B move out of the cell coverage of the BS 104 and enter the cell coverage of the BS 106, while the UE 102C and 102D remain in the cell coverage of the BS 104.

The CN 110 later in time initiates 373 a Session activation notification for the MBS with the BS 104, and the cell coverage of the BS 104 reaches. The UE 102C and 102D thereby activate 323 MBS reception. The UE 102C and 102D perform 382 connection resume procedure with the BS 104. The MBS data transmission 393 may take place from the CN 110 to the BS 104 and then to the UEs including the UE 102C and 102D.

The BS 104 transmits 363, to the BS 106, one of the BS in the configured RAN Notification Area, a BS-to-BS interface message including MBS Session ID(s), and/or an indication of the identities of UEs that have previously indicated an interest in the MBS service including the UE 102A and 102B, and/or respective UE radio capability for paging IE(s), which may respectively include an inactiveStatePODetermination indication for UE(s) including the UE 102A and 102B, the respective useIdlePO configuration(s), and/or respective UE-specific DRX for UE(s) including the UE 102A and 102B. In some implementations, the BS-to-BS interface message is a RAN MULTICAST GROUP PAGING message defined in 3GPP TS 38.423.

After receiving 363 the BS-to-BS interface message, if the BS 106 is an aggregated base station (i.e., no CU-DU split), the BS 106 determines 339 paging occasions for UE(s) including the UE 102A and 102B based on the received respective UE radio capability for paging IE(s), the respective useIdlePO configuration(s), and/or the respective UE-specific DRX(s). In some implementations, the BS 106 determines (first) paging occasions for the UE(s) including the UE 102A and UE 102B according to parameters used for the idle state in response to receiving the respective useIdlePO configuration for the UE(s) including the UE 102A and 102B. The BS 106 transmits 391 one or more paging message(s) (e.g., Paging message defined in 3GPP TS 38.331 or 36.331) including the MBS Session ID to the UE(s) including the UE 102A and UE 102B within/on the (first) paging occasions. In such cases, the UE 102A and UE 102B determine the same paging occasions according to the parameters used for the idle state in response to receiving the useIdlePO configuration.

In some implementations, in cases where the useIdlePO configuration is absent for UE(s) including the UE 102A and 102B, the BS 106 calculates (second) paging occasions for the UE(s) including the UE 102A and 102B using parameters for the inactive state. In such cases, the BS 106 transmits 391 one or more paging message(s) (e.g., Paging message defined in 3GPP TS 38.331 or 36.331) including the MBS Session ID(s) to the UE(s) including the UE 102A and 102B within/on the (second) paging occasions. The UE 102A and 102B also determine the same paging occasions according to the parameters used for the inactive state in response to or because of the useIdlePO configuration is absent.

In cases where the BS 106 has a CU-DU split architecture, the determination of paging occasions and transmissions of paging messages is similar to event 381 the session activation notification procedure for the UE 102A and CU/DU of BS 106.

The events 363, 339, and 391 can be collectively referred to as a RAN session activation procedure including an Xn RAN Paging 375 for MBS. The UE 102A and 102B thereby activates 323 MBS reception.

The UE 102A and 102B perform 383 connection resume procedure with UE context retrieval with the BS 106, BS 104, and CN 110. If received in event 373, the BS 104 may forward 346 the MBS data to the BS 106 and the BS 106 transmits 347 the MBS data to the UE 102A. The CN 110 transmits 348 a MBS data to the BS 106 and the BS 106 transmits 349 the MBS data to the UE 102A and 102B.

Turning to FIGS. 4A-4C, scenarios 400A, 400B, and 400C include UE-triggered RAN Notification Area (RNA) update procedures involving context retrieval over an Xn interface. The RNA update procedures may be triggered when the UE moves out of the configured RNA, or periodically.

Referring first to FIG. 4A, the BS 104 may, at some time, perform a BS Configuration Update procedure (e.g., NG-RAN node Configuration Update) with the BS 106 by transmitting 404 a BS Configuration Update message to the BS 106 and receiving 406 a BS Configuration Update Acknowledge message from the BS 106. In some implementations, the BS Configuration Update procedure exchanges the BS capability for supporting paging occasion alignment for the RRC idle and inactive states, as described in the previous example scenarios. In other implementations, this capability is exchanged via OAM (Operations, Administration, and Maintenance).

Initially, the UE 102A performs 362 the connection release procedure with suspendConfig with the BS 104 and transitions 408 to the inactive state. The UE 102A later moves into the cell coverage of the BS 106 and decides to perform an RNA update. The UE 102A may perform 431 a random access procedure with the BS 106. The UE 102A transmits 445 an RRC resume request message to the BS 106 with the cause RNA update and the I-RNTI assigned by the BS 104. The BS 106 transmits 447 a RETRIEVE UE CONTEXT REQUEST message with the cause RNA update to the BS 104. The BS 104 decides to relocate the UE Context for the UE 102A to the BS 106 and transmits 448, to the BS 106, a RETRIEVE UE CONTEXT RESPONSE message including an RRC Context container (e.g., HandoverPreparationInformation message as defined in 3GPP TS 38.331), which may include the UE capability (e.g., ue-CapabilityRAT-List, and/or UE radio capability for paging, which may include an inactiveStatePODetermination indication), and/or the useIdlePO configuration, and/or the UE-specific DRX. In some implementations, the UE-specific DRX is not located in the RRC Context container, but is included separately in the RETRIEVE UE CONTEXT RESPONSE message. At event 418, the BS 106 determines to transition the UE 102A to the inactive state and determines paging occasion based on the received information for the inactive state from the RETRIEVE UE CONTEXT RESPONSE message. In some implementations, the determination of paging occasion(s) at event 418 may be similar to the event 318, 319, 338, or 339, as described in scenarios 300A to 300D. The BS 106 may transmit 454 an Xn-U ADDRESS INDICATION message for data forwarding to the BS 104. The BS 106 transmits 456 a PATH SWITCH REQUEST message to the CN 110. The CN 110 in response transmits 458 a PATH SWITCH REQUEST ACKNOWLEDGE message to the BS 106. The BS 106 transmits 460 a UE CONTEXT RELEASE message to the BS 104 to release the context for the UE 102A. The BS 106 transmits 465 an RRC release message, which may include or not include the useIdlePO configuration to the UE 102A. The UE 102A remains in the inactive state after receiving the RRC release message and derives paging occasions according to the configurations.

Next referring to FIG. 4B, a scenario 400B also depicts an RNA update similar to the scenario 400A, but where the last serving base station, BS 104, decides not to relocate the UE Context and configures the UE to remain in the inactive state. The differences between the scenarios of FIG. 4B and FIG. 4A are discussed below.

Similar to scenario 400A, the BS 104 and BS 106 may, at some time, perform BS Configuration Update procedure(s) to exchange the capability for supporting aligning paging occasions for the RRC idle and inactive states. The UE 102A performs 362 the connection release procedure with suspendConfig with BS 104 and transitions 408 to the inactive state. The UE 102A later moves to the cell coverage of BS 106.

The UE 102A decides to initiate an RNA update and may perform 431 a random access procedure with the BS 106. The UE 102A transmits 445 an RRC resume request message to the BS 106 with the cause RNA update and the I-RNTI assigned by the BS 104. The BS 106 transmits 447 a RETRIEVE CONTEXT REQUEST message with the cause RNA update to the BS 104. At event 468, the BS 104 decides to transition the UE 102A to the inactive state without relocating the UE Context for the UE 102A and determines whether the BS 106 supports the useIdlePO function. The BS 104 transmits 449 a RETRIEVE UE CONTEXT FAILURE message including an RRC release message, which may include or not include the useIdlePO configuration. The BS 106 transmits 465 the RRC release message to the UE 102A.

Referring now to FIG. 4C, the scenario 400C is similar to scenario 400A, but where the BS 106 decides to resume the UE RRC connection after the UE Context retrieval. The differences between the scenarios of FIG. 4C and FIGS. 4A and 4B are discussed below.

Similar to scenario 400A, the BS 104 and BS 106 may at some time perform BS Configuration Update procedure(s) to exchange the capability for supporting aligning paging occasions for the RRC idle and inactive states. The UE 102A performs 362 the connection release procedure with suspendConfig with BS 104 and transitions 408 to the inactive state. The UE 102A later moves to the cell coverage of the BS 106.

The UE 102A decides to initiate an RNA update and may perform 431 a random access procedure with BS 106. The UE 102A transmits 445 an RRC resume request message to the BS 106 with the cause RNA update and the I-RNTI assigned by the BS 104. The BS 106 transmits 447 a RETRIEVE UE CONTEXT REQUEST message with the cause RNA update to the BS 104. The BS 104 decides to relocate the UE Context for the UE 102A to the BS 106 and transmits 448, to the BS 106, a RETRIEVE UE CONTEXT RESPONSE message including an RRC Context container (e.g., HandoverPreparationInformation as defined in 3GPP TS 38.331), which may include the UE capability (e.g., ue-CapabilityRAT-List, and/or UE radio capability for paging, which may include an inactiveStatePODetermination indication), and/or the useIdlePO configuration, and/or the UE-specific DRX. In some implementations, the UE-specific DRX is not located in the RRC Context container but is included separately in the RETRIEVE UE CONTEXT RESPONSE message. The BS 106 decides to transition UE 102A to the connected state and transmits 450 an RRC resume message to the UE 102A. The UE 102A transitions 450 to the connected state and transmits 452 an RRC resume complete message to the BS 106. The BS 106 may transmit 454 an Xn-U ADDRESS INDICATION for data forwarding to the BS 104. The BS 106 transmits 456 a PATH SWITCH REQUEST message to the CN 110. The CN 110 in response transmits 458 a PATH SWITCH REQUEST ACKNOWLEDGE message to the BS 106. The BS 106 transmits 460 a UE CONTEXT RELEASE message to the BS 104.

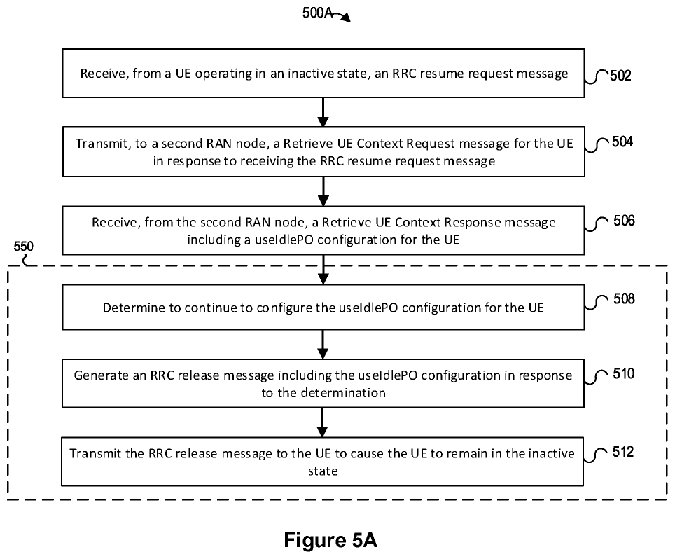

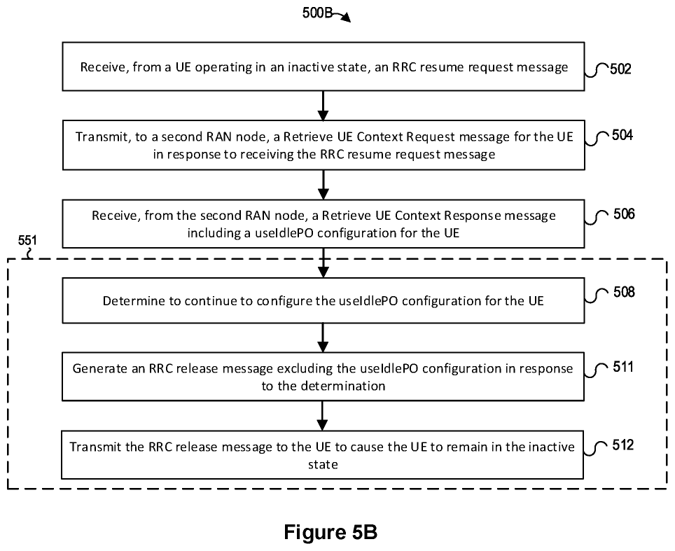

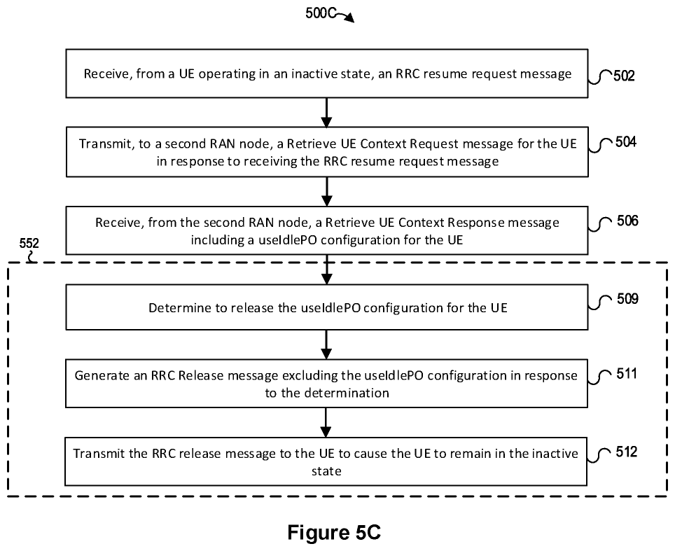

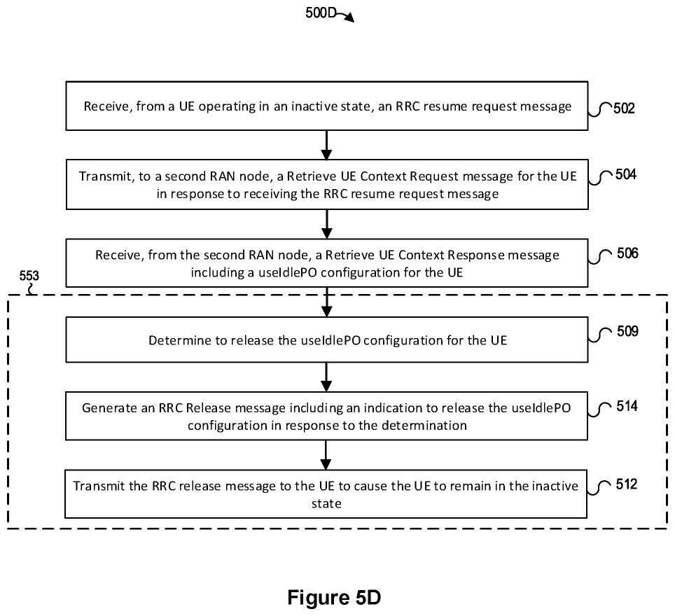

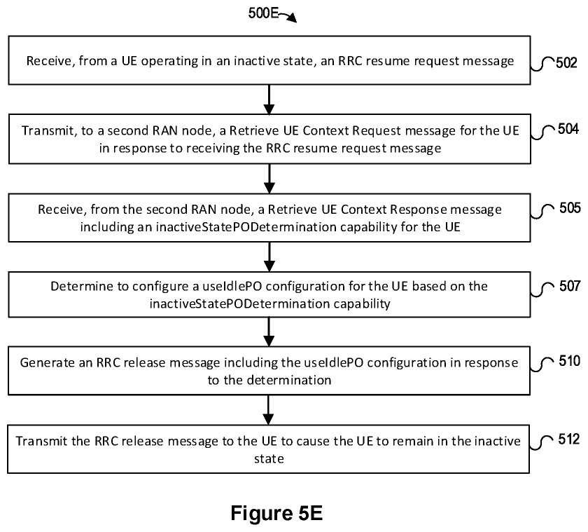

Next, several example methods that devices illustrated in FIGS. 1A-1B may perform are discussed with reference to FIGS. 5A-5E, and 6-12. As indicated at various points below, the example methods depicted in FIGS. 5A-5E and 6-12 may be implemented during the scenarios 300A-300D and 400A-400C described above.

Referring next to FIG. 5A, FIG. 5A illustrates an example method 500A for determining paging configurations for a UE operating in an inactive state, such as the UE 102A, which can be implemented in a base station such as the BS 106 of FIGS. 4A-4C or in a base station CU such as the CU 172, for example.

The method begins at block 502, where the base station receives, from a UE operating in an inactive state, an RRC resume request message (e.g., event 445 of FIGS. 4A-4C). At block 504, the base station transmits, to a second RAN node, a RETRIEVE UE CONTEXT REQUEST message for the UE in response to receiving the RRC resume request message (e.g., event 447 of FIGS. 4A-4C). The base station at block 506 receives, from the second RAN node, a RETRIEVE UE CONTEXT RESPONSE message including a useIdlePO configuration for the UE (e.g., event 448 of FIGS. 4A and 4C). The base station at block 508 determines to continue to configure the useIdlePO configuration for the UE. At block 510, the base station generates an RRC release message including the useIdlePO configuration in response to the determination. The base station at block 512 transmits the RRC release message to the UE to cause the UE to remain in the inactive state (e.g., event 462 of FIG. 4A). The blocks 508, 510, and 512 can be collectively referred to as event 550.

In some implementations, the useIdlePO configuration is set to the value “true,” such that the base station (or the DU of the base station) calculates the PO for the UE according to the parameters used for the idle state. In other implementations, the useIdlePO configuration is absent, such that the base station (or the DU of the base station) calculates the paging occasions for the UE using the parameters for the inactive state. In some implementations, if included, the useIdlePO configuration is located in a container IE (e.g., suspendConfig or cellReselectionPriorities) and it configures UE to use parameters for the idle state to calculate paging occasions while the UE operates in the inactive state. In other implementations, if included, the useIdlePO configuration is not located in the container IE.

Referring next to FIG. 5B, FIG. 5B illustrates an example method 500B, which is similar to the method 500A, for determining paging configurations for a UE operating in an inactive state, such as the UE 102A. The method 500B can be implemented in a base station such as the BS 106 of FIGS. 4A-4C or in a base station CU such as the CU 172 for example.

The method begins at block 502, where the base station receives, from a UE operating in an inactive state, an RRC resume request message (e.g., event 445 of FIGS. 4A-4C). At block 504, the base station transmits, to a second RAN node, a RETRIEVE UE CONTEXT REQUEST message for the UE in response to receiving the RRC resume request message (e.g., event 447 of FIGS. 4A-4C). The base station at block 506 receives, from the second RAN node, a RETRIEVE UE CONTEXT RESPONSE message including a useIdlePO configuration for the UE (e.g., event 448 of FIGS. 4A and 4C). The base station at block 508 determines to continue to configure the useIdlePO configuration for the UE. At block 511, the base station generates an RRC release message excluding the useIdlePO configuration in response to the determination. The base station at block 512 transmits the RRC release message to the UE to cause the UE to remain in the inactive state (e.g., event 462 of FIG. 4A). The blocks 508, 511, and 512 can be collectively referred to as event 551.

In some implementations, the useIdlePO configuration is set to the value “true,” such that the base station (or the DU of the base station) calculates the PO for the UE according to the parameters used for the idle state. In other implementations, the useIdlePO configuration is absent, such that the base station (or the DU of the base station) calculates the paging occasions for the UE using the parameters for the inactive state. In some implementations, if included, the useIdlePO configuration is located in a container IE (e.g., suspendConfig or cellReselectionPriorities) and it configures UE to use parameters for the idle state to calculate paging occasions while the UE operates in the inactive state. In other implementations, if included, the useIdlePO configuration is not located in the container IE.

Referring next to FIG. 5C, an example method 500C similar to 500A and 500B for determining paging configurations for a UE operating in an inactive state, such as the UE 102A. The method 500C can be implemented in a base station such as the BS 106 of FIGS. 4A-4C or in a base station CU such as the CU 172, for example.

The method begins at block 502, where the base station receives, from a UE operating in an inactive state, an RRC resume request message (e.g., event 445 of FIGS. 4A-4C). At block 504, the base station transmits, to a second RAN node, a RETRIEVE UE CONTEXT REQUEST message for the UE in response to receiving the RRC resume request message (e.g., event 447 of FIGS. 4A-4C). The base station at block 506 receives, from the second RAN node, a RETRIEVE UE CONTEXT RESPONSE message including a useIdlePO configuration for the UE (e.g., event 448 of FIGS. 4A and 4C). The base station at block 509 determines to release the useIdlePO configuration for the UE. At block 511, the base station generates an RRC release message excluding the useIdlePO configuration in response to the determination. The base station at block 512 transmits the RRC release message to the UE to cause the UE to remain in the inactive state (e.g., event 462 of FIG. 4A). The blocks 509, 511, and 512 can be collectively referred to as event 552.

In some implementations, the first RAN node determines to release the useIdlePO configuration because the first RAN node does not support the useIdlePO configuration. In such cases, the first RAN node refrains from sending the UE an RRC message (e.g., RRC resume message) including a full configuration indication to release the useIdlePO configuration.

Referring next to FIG. 5D, FIG. 5D illustrates an example method 500D, which is similar to the methods 500A, 500B and 500C, for determining paging configurations for a UE operating in an inactive state, such as the UE 102A. The method 500D can be implemented in a base station such as the BS 106 of FIGS. 4A-4C or in a base station CU such as the CU 172, for example.

The method begins at block 502, where the base station receives, from a UE operating in an inactive state, an RRC resume request message (e.g., event 445 of FIGS. 4A-4C). At block 504, the base station transmits, to a second RAN node, a RETRIEVE UE CONTEXT REQUEST message for the UE in response to receiving the RRC resume request message (e.g., event 447 of FIGS. 4A-4C). The base station at block 506 receives, from the second RAN node, a RETRIEVE UE CONTEXT RESPONSE message including a useIdlePO configuration for the UE (e.g., event 448 of FIGS. 4A and 4C). The base station at block 509 determines to release the useIdlePO configuration for the UE. At block 514, the base station generates an RRC release message including an indication to release the useIdlePO configuration in response to the determination. The base station at block 512 transmits the RRC release message to the UE to cause the UE to remain in the inactive state (e.g., event 462 of FIG. 4A). The blocks 509, 514, and 512 can be collectively referred to as event 553.

In some implementations, the indication can be a new field or IE indicating to the UE to release the useIdlePO configuration.

Referring next to FIG. 5E, FIG. 5E illustrates an example method 500E, which is similar to the methods 500A, 500B, 500C and 500D, for determining paging configurations for a UE operating in an inactive state, such as the UE 102A. The method 500E can be implemented in a base station such as the BS 106 of FIGS. 4A-4C or in a base station CU such as the CU 172, for example.

The method begins at block 502, where the base station receives, from a UE operating in an inactive state, an RRC resume request message (e.g., event 445 of FIGS. 4A-4C). At block 504, the base station transmits, to a second RAN node, a RETRIEVE UE CONTEXT REQUEST message for the UE in response to receiving the RRC resume request message (e.g., event 447 of FIGS. 4A-4C). The base station at block 505 receives, from the second RAN node, a RETRIEVE UE CONTEXT RESPONSE message including an inactiveStatePODetermination capability for the UE (e.g., event 448 of FIGS. 4A and 4C). The base station at block 507 determines to configure a useIdlePO configuration for the UE based on the inactiveStatePODetermination capability. At block 510, the base station generates an RRC release message including the useIdlePO configuration in response to the determination. The base station at block 512 transmits the RRC release message to the UE to cause the UE to remain in the inactive state (e.g., event 462 of FIG. 4A).

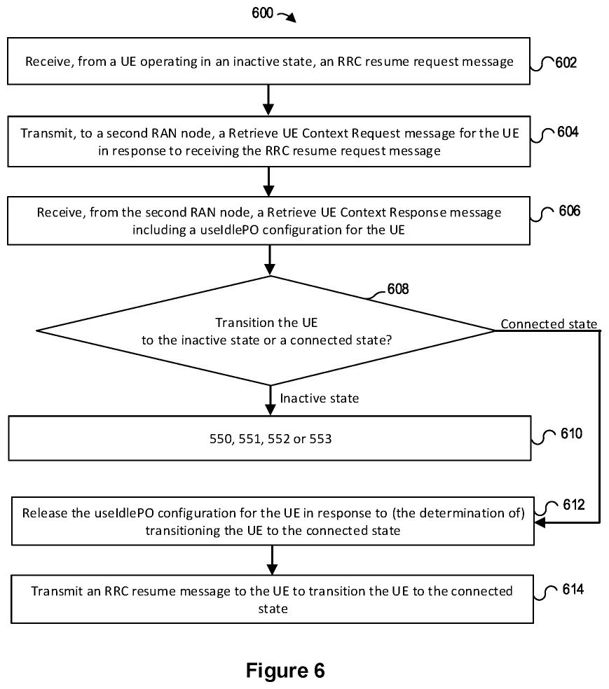

Referring next to FIG. 6, FIG. 6 illustrates an example method 600, which is similar to the methods 500A-500E, for determining paging configurations for a UE operating in an inactive state, such as the UE 102A. The method 600 can be implemented in a base station such as the BS 106 of FIGS. 4A-4C or in a base station CU such as the CU 172, for example.

The method begins at block 602, where the base station receives, from a UE operating in an inactive state, an RRC resume request message (e.g., event 445 of FIGS. 4A-4C). At block 604, the base station transmits, to a second RAN node, a RETRIEVE UE CONTEXT REQUEST message for the UE in response to receiving the RRC resume request message (e.g., event 447 of FIGS. 4A-4C). The base station at block 606 receives, from the second RAN node, a RETRIEVE UE CONTEXT RESPONSE message including a useIdlePO configuration for the UE (e.g., event 448 of FIG. 4A). The base station at block 608 determines whether to transition the UE to the inactive state or a connected state. If the determination is to the inactive state, the flow proceeds to block 610 where the base station performs 550, 551, 552, or 553 (e.g., event 462 of FIG. 4A). On the other hand, if the determination is to the connected state, the flow proceeds to block 612, where the base station releases the useIdlePO configuration for the UE in response to (the determination of) transitioning the UE to the connected state. At block 614, the base station transmits an RRC resume message to the UE to transition the UE to the connected state (e.g., event 450 of FIG. 4C).

In some implementations, the first RAN node determines to transition the UE to the connected state because the first RAN node does not support the useIdlePO configuration. In other implementations, the first RAN node determines to transition the UE to the connected state because the RAN node does not support RNA update without state transition. In yet other implementations, the first RAN node determines to transition the UE to the connected state because the first RAN node and the UE need to communicate data with one another.

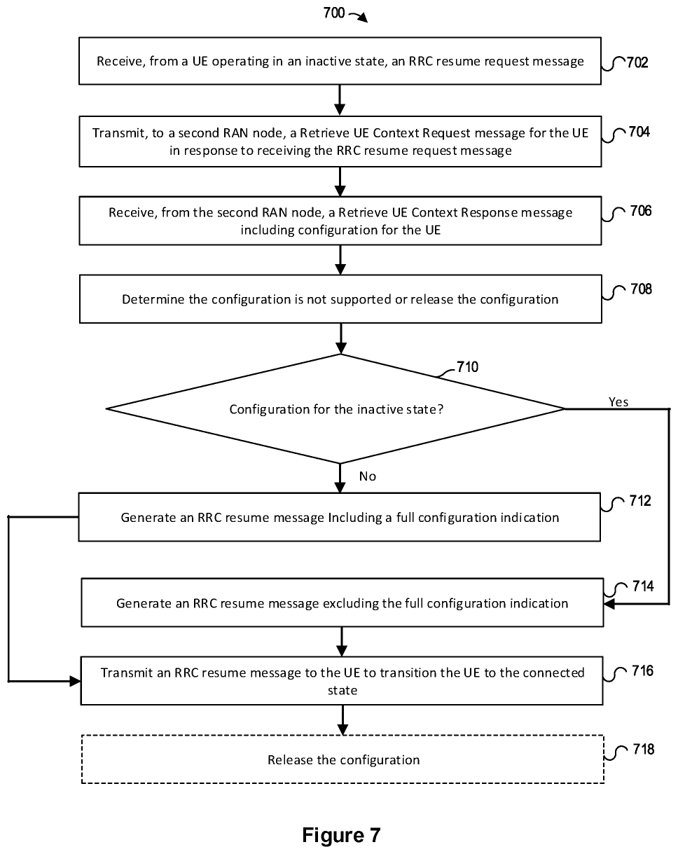

Referring next to FIG. 7, FIG. 7 illustrates an example method 700, which is similar to the method 600, for determining paging configurations for a UE operating in an inactive state, such as the UE 102A. The method 700 can be implemented in a base station such as the BS 106 of FIGS. 4A-4C or in a base station CU such as the CU 172, for example.

The method begins at block 702, where the base station receives, from a UE operating in an inactive state, an RRC resume request message (e.g., event 445 of FIGS. 4A-4C). At block 704, the base station transmits, to a second RAN node, a RETRIEVE UE CONTEXT REQUEST message for the UE in response to receiving the RRC resume request message (e.g., event 447 of FIGS. 4A-4C). The base station at block 706 receives, from the second RAN node, a RETRIEVE UE CONTEXT RESPONSE message including configuration for the UE (e.g., event 448 of FIG. 4A). The base station at block 708 determines that the configuration is not supported or determines to release the configuration. At block 710 the base station determines whether the configuration is for the inactive state. For example, the useIdlePO configuration is a configuration to be used for UE(s) operating in inactive state. If the determination is YES (i.e., the configuration is for the inactive state), the flow proceeds to block 714 where the base station generates an RRC resume message excluding the full configuration indication. The flow then proceeds to block 716 where the base station transmits an RRC resume message to the UE to transition the UE to the connected state (e.g., event 450 of FIG. 4C). The base station may then at block 718 release the configuration, for example, because the base station does not support the configuration or does not want to enable the configuration. There may be no strict order of blocks (712, 716) and 718.

On the other hand, if the determination is NO (i.e., the configuration is not for the inactive state), the flow proceeds to block 712, where the base station generates an RRC resume message including a full configuration indication. The flow then also proceeds to block 716 where the base station transmits an RRC resume message to the UE to transition the UE to the connected state (e.g., event 450 of FIG. 4C). The base station may then at block 718 release the configuration, for example, because the base station does not support the configuration or does not want to enable the configuration. There may be no strict order of blocks (712, 716) and 718.

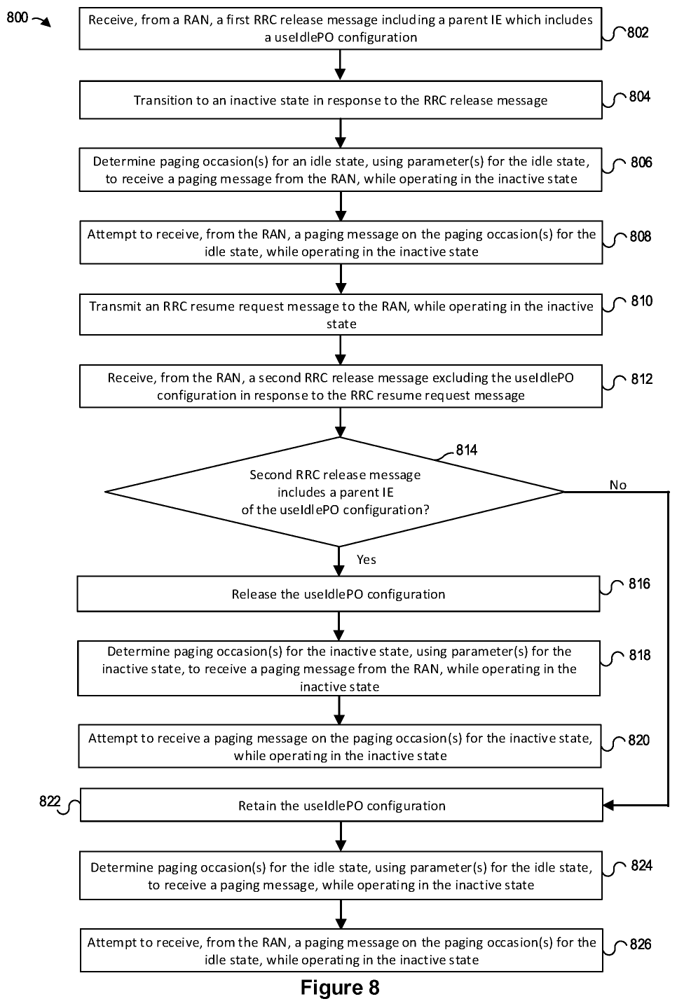

Referring next to FIG. 8, FIG. 8 illustrates an example method 800 for determining paging configurations for a UE operating in an inactive state, which can be implemented in a UE such as the UE 102A of FIGS. 3A-3D and 4A-4C, for example.

The method begins at block 802, where the UE receives from a RAN a first RRC release message including a parent IE, which includes a useIdlePO configuration (e.g., event 306 of FIG. 3A or event 362 of FIG. 4A). At block 804, the UE transitions to an inactive state in response to the RRC release message (e.g., event 308 of FIG. 3A or event 408 of FIG. 4A). The UE at block 806 determines paging occasion(s) for an idle state, using parameter(s) for the idle state, to receive a paging message from the RAN, while the UE is operating in the inactive state. The UE at block 808 attempts to receive from the RAN a paging message on the paging occasion(s) for the idle state, while the UE is operating in the inactive state. At block 810, the UE transmits an RRC resume request message to the RAN, while the UE is operating in the inactive state. At block 812, the UE receives from the RAN a second RRC release message excluding the useIdlePO configuration in response to the RRC resume request message (e.g., event 462 of FIG. 4A). The UE 102A at block 814 determines whether the second RRC release message includes a parent IE of the useIdlePO configuration. For example, the parent IE is a container IE as described above such as the suspendConfig IE or CellReselectionPriorities IE. If the determination is YES (i.e., the second RRC release message includes a parent IE of the useIdlePO configuration), the flow proceeds to block 816 where the UE releases the useIdlePO configuration. The UE at block 818 determines paging occasion(s) for the inactive state, using parameter(s) for the inactive state, to receive a paging message from the RAN, while operating in the inactive state. The UE at block 820 attempts to receive a paging message on the paging occasion(s) for the inactive state, while the UE is operating in the inactive state.

On the other hand, if the determination at block 814 is NO (i.e., the second RRC release message does not include a parent IE of the useIdlePO configuration), the flow proceeds to block 822 where the UE retains the useIdlePO configuration. The UE at block 824 determines paging occasion(s) for the idle state, using parameter(s) for the idle state, to receive a paging message, while the UE is operating in the inactive state. At block 826, the UE attempts to receive, from the RAN, a paging message on the paging occasion(s) for the idle state, while the UE is operating in the inactive state.

In cases where the UE operates in the inactive state with a gNB of the RAN, the parent IE in some implementations can be SuspendConfig IE defined in 3GPP TS 38.331. Alternatively, the parent IE can be a CellReselectionPriorities IE defined in 3GPP TS 38.331. Yet alternatively, the parent IE can be a (new) IE that is neither the SuspendConfig IE nor the CellReselectionPriorities IE. In this case, the parent IE can be an RRCRelease-v16xy-IEs IE, where x and y are integers and x>6 (e.g., x can be 7 or 8) and y>=0.

In cases where the UE operates in the inactive state with a ng-eNB of the RAN, the parent IE in some implementations can be an RRC-InactiveConfig-v17xy IE defined in 3GPP TS 36.331, where x and y are integers and x>−0 and y>=0. Alternatively, the parent IE can be an RRC-InactiveConfig-v16xy IE defined in 3GPP TS 36.331, where x and y are integers and x>6 (e.g., x can be 7 or 8) and y>=0.

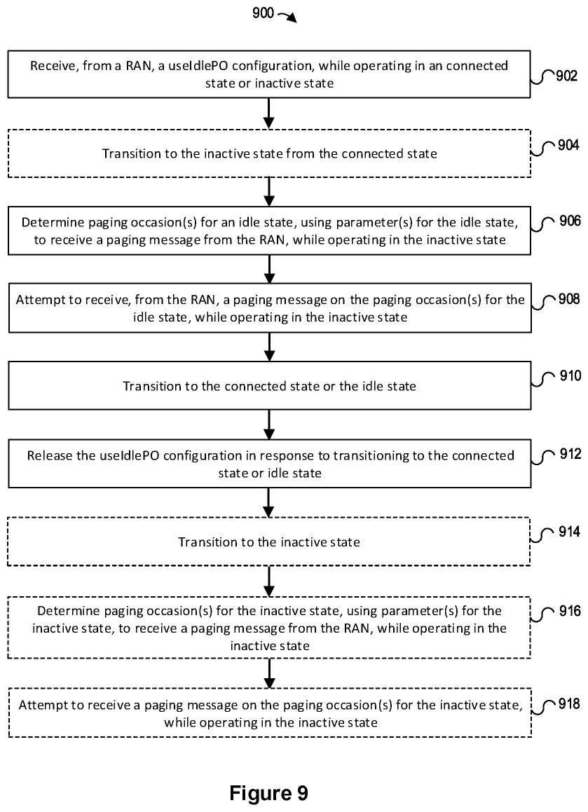

Referring next to FIG. 9, FIG. 9 illustrates an example method 900 for determining paging configurations for an inactive state UE, which can be implemented in a UE such as the UE 102A of FIGS. 3A-3D and 4A-4C, for example.

The method begins at block 902, where the UE receives from a RAN a useIdlePO configuration, while operating in a connected state or inactive state (e.g., event 306 of FIG. 3A or event 362 of FIG. 4A). The UE at block 904 may transition to the inactive state from the connected state. The UE at block 906 determines paging occasion(s) for an idle state, using parameter(s) for the idle state, to receive a paging message from the RAN, while operating in the inactive state. At block 908, the UE attempts to receive, from the RAN, a paging message on the paging occasion(s) for the idle state, while operating in the inactive state. At block 910, the UE transitions to the connected state or the idle state. The UE at block 912 releases the useIdlePO configuration in response to transitioning to the connected state or idle state. The UE at block 914 may transition to the inactive state. At block 916, the UE may determine paging occasion(s) for the inactive state, using parameter(s) for the inactive state, to receive a paging message from the RAN, while operating in the inactive state. At block 918, the UE may attempt to receive a paging message on the paging occasion(s) for the inactive state, while operating in the inactive state.

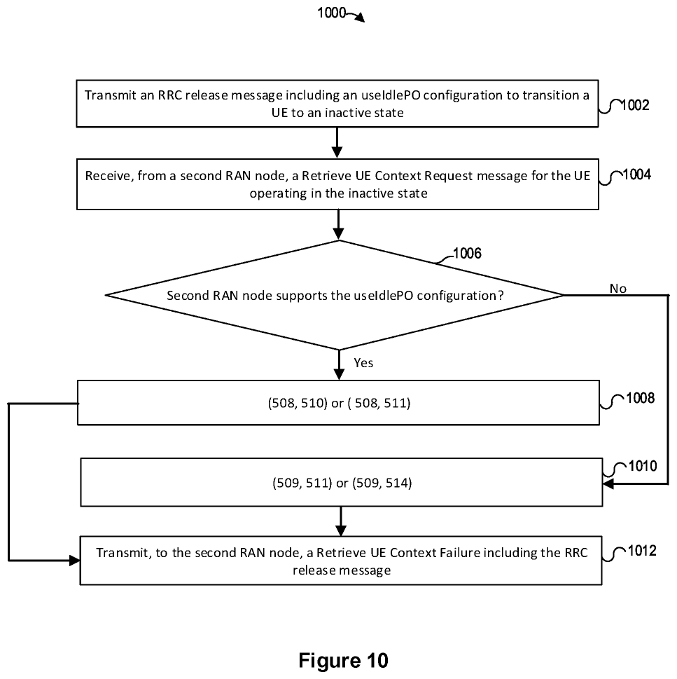

Referring next to FIG. 10, FIG. 10 illustrates an example method 1000 for determining paging configurations for an UE operating in an inactive state, such as the UE 102A. The method 1000 can be implemented in a base station such as the BS 104 of FIG. 4B or in a base station CU such as the CU 172, for example.

The method begins at block 1002, where the base station transmits an RRC release message including a useIdlePO configuration to transition a UE to an inactive state (e.g., event 362 of FIGS. 4A-4C). At block 1004, the base station receives, from a second RAN node, a RETRIEVE UE CONTEXT REQUEST message for the UE operating in the inactive state (e.g., event 447 of FIGS. 4A-4C). The base station at block 1006 determines whether the second RAN node supports the useIdlePO configuration. If the determination is YES (i.e., the useIdlePO configuration is supported), the flow proceeds to block 1008 where the base station performs blocks 508 and 510, or blocks 508 and 511. The base station then, at block 1012, transmits to the second RAN node a RETRIEVE UE CONTEXT FAILURE message including the RRC release message.

On the other hand, if the determination is NO (i.e., the useIdlePO configuration is not supported), the flow proceeds to block 1010 where the base station performs blocks 509 and 511, or blocks 509 and 514. The base station then, at block 1012, transmits to the second RAN node a RETRIEVE UE CONTEXT FAILURE message including the RRC release message.

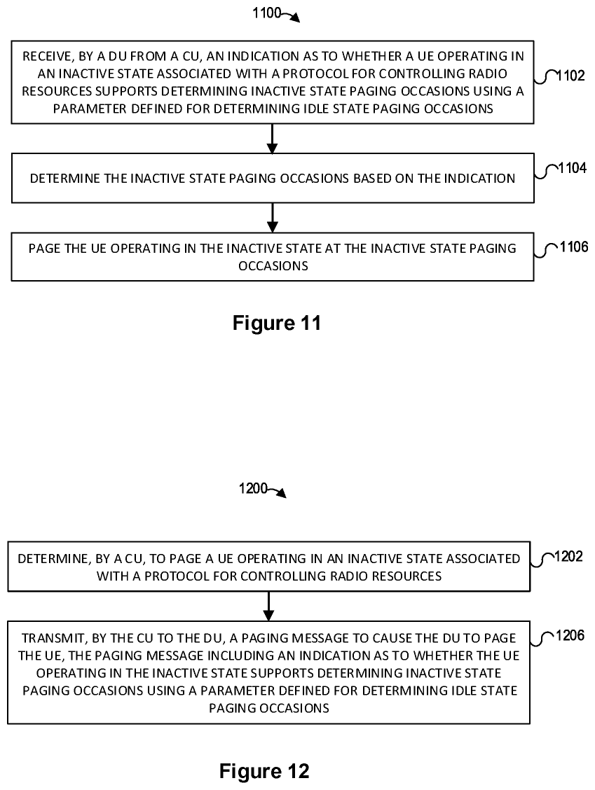

FIG. 11 illustrates a method 1100 for determining paging occasions, which can be performed by a DU (e.g., the DU 174). At block 1102, the DU receives, from the CU (e.g., the CU 172), an indication as to whether a UE (e.g., the UE 102) operating in an inactive state associated with a protocol for controlling radio resources supports determining inactive state paging occasions using a parameter defined for determining idle state paging occasions (e.g., event 316, 315). The DU 174 determines, at block 1104, the inactive state paging occasions based on the indication (e.g., event 318, 319), and pages, at block 1106, the UE operating in the inactive state at the inactive state paging occasions (e.g., event 320, 321).

FIG. 12 illustrates a method 1200 for managing paging occasion determination, which can be performed by a CU (e.g., the CU 172). At block 1202, the CU determines to page a UE (e.g., the UE 102) operating in an inactive state associated with a protocol for controlling radio resources (e.g., in response to event 309, 310, 313, 314). At block 1204, the CU transmits, to a DU (e.g., the DU 174) a paging message to cause the DU to page the UE, the paging message including an indication as to whether the UE operating in the inactive state supports determining inactive state paging occasions using a parameter defined for determining idle state paging occasions (e.g., event 316, 315).

The list of examples below reflects a variety of the embodiments explicitly contemplated herein:

Example 1 is a method for determining paging occasions, the method performed by a distributed unit (DU) of a distributed base station including a central unit (CU) and the DU, and the method comprising: receiving, by the DU from the CU, an indication as to whether a user equipment (UE) operating in an inactive state associated with a protocol for controlling radio resources supports determining inactive state paging occasions using a parameter defined for determining idle state paging occasions; determining, by the DU, the inactive state paging occasions based on the indication; and paging, by the DU, the UE operating in the inactive state at the inactive state paging occasions.

Example 2 is the method of example 1, wherein: the receiving of the indication includes receiving the indication indicating that the UE supports determining the inactive state paging occasions using the parameter defined for determining the idle state paging occasions; and the determining of the inactive state paging occasions includes determining the inactive state paging occasions using the parameter defined for determining the idle state paging occasions.

Example 3 is the method of example 1, wherein: the receiving of the indication includes receiving the indication indicating that the UE does not support determining the inactive state paging occasions using the parameter defined for determining the idle state paging occasions; and the determining of the inactive state paging occasions includes determining the inactive state paging occasions using a parameter defined for determining inactive state paging occasions.

Example 4 is the method of any one of the preceding examples, further comprising: receiving, by the DU from the CU, a configuration enabling the UE to use the parameter defined for determining the idle state paging occasions to determine the inactive state paging occasions, wherein the determining of the inactive state paging occasions is further based on the configuration.

Example 5 is the method of any one of the preceding examples, wherein the receiving of the indication includes: receiving an inactiveStatePODetermination indication.

Example 6 is the method of any one of the preceding examples, wherein the receiving of the indication includes: receiving the indication in a paging message.

Example 7 is the method of example 6, wherein the paging message is formatted in accordance with a protocol having termination points at the CU and the DU.

Example 8 is a method for managing paging occasion determination, the method performed by a central unit (CU) of a distributed base station including the CU and a distributed unit (DU), and the method comprising: determining, by the CU, to page a user equipment (UE) operating in an inactive state associated with a protocol for controlling radio resources; and transmitting, by the CU to the DU, a paging message to cause the DU to page the UE, the paging message including an indication as to whether the UE operating in the inactive state supports determining inactive state paging occasions using a parameter defined for determining idle state paging occasions.

Example 9 is the method of example 8, further comprising: receiving, prior to transmitting the paging message, the indication at the CU from another base station.

Example 10 is the method of example 9, wherein the receiving of the indication includes: receiving a RAN PAGING message including the indication.

Example 11 is the method of example 8, further comprising: receiving, prior to transmitting the paging message, a UE capability information element from at least one of the UE, a core network (CN), or another base station; and determining, by the CU, based on the UE capability information element, whether the UE supports determining the inactive state paging occasions using the parameter defined for determining idle state paging occasions.

Example 12 is the method of any one of examples 8-11, further comprising: transmitting, by the CU to the DU in the paging message, a configuration enabling the UE to use the parameter defined for determining the idle state paging occasions to determine the inactive state paging occasions.

Example 13 is the method of any one of examples 8-12, wherein the transmitting of the paging message including the indication includes: transmitting the paging message including an inactiveStatePODetermination indication.

Example 14 is the method of any one of examples 8-13, wherein the transmitting of the paging message includes: transmitting the paging message formatted in accordance with a protocol having termination points at the CU and the DU.

Example 15 is a network node of a distributed base station, the network node comprising processing hardware and configured to implement a method according to any one of the preceding examples.

The following description may be applied to the description above.

Generally speaking, description for one of the above figures can apply to another of the above figures. Examples, implementations, and methods described above can be combined, if there is no conflict. An event or block described above can be optional or omitted. For example, an event or block with dashed lines or an information element in brackets in the figures can be optional. In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the above-described methods can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the methods can be provided as part of the operating system, a library used by multiple applications, a particular software application, etc. The software can be executed by one or more general-purpose processors or one or more special-purpose processors.

1. A method for determining paging occasions, the method performed by a distributed unit (DU) of a distributed base station including a central unit (CU) and the DU, and the method comprising:
receiving, by the DU from the CU, an indication as to whether a user equipment (UE) operating in an inactive state associated with a protocol for controlling radio resources supports determining inactive state paging occasions using a parameter defined for determining idle state paging occasions;
determining, by the DU, the inactive state paging occasions based on the indication; and
paging, by the DU, the UE operating in the inactive state at the inactive state paging occasions.

2. The method of claim 1, wherein:
the receiving of the indication includes receiving the indication indicating that the UE supports determining the inactive state paging occasions using the parameter defined for determining the idle state paging occasions; and
the determining of the inactive state paging occasions includes determining the inactive state paging occasions using the parameter defined for determining the idle state paging occasions.

3. The method of claim 1, wherein:
the receiving of the indication includes receiving the indication indicating that the UE does not support determining the inactive state paging occasions using the parameter defined for determining the idle state paging occasions; and
the determining of the inactive state paging occasions includes determining the inactive state paging occasions using a parameter defined for determining inactive state paging occasions.

4. The method of claim 1, further comprising:
receiving, by the DU from the CU, a configuration enabling the UE to use the parameter defined for determining the idle state paging occasions to determine the inactive state paging occasions,
wherein the determining of the inactive state paging occasions is further based on the configuration.

5. The method of claim 1, wherein the receiving of the indication includes:
receiving an inactiveStatePODetermination indication.

6. The method of claim 1, wherein the receiving of the indication includes:
receiving the indication in a paging message.

7. The method of claim 6, wherein the paging message is formatted in accordance with a protocol having termination points at the CU and the DU.

8. A method for managing paging occasion determination, the method performed by a central unit (CU) of a distributed base station including the CU and a distributed unit (DU), and the method comprising:
determining, by the CU, to page a user equipment (UE) operating in an inactive state associated with a protocol for controlling radio resources; and
transmitting, by the CU to the DU, a paging message to cause the DU to page the UE, the paging message including an indication as to whether the UE operating in the inactive state supports determining inactive state paging occasions using a parameter defined for determining idle state paging occasions.

9. The method of claim 8, further comprising:
receiving, prior to transmitting the paging message, the indication at the CU from another base station.

10. The method of claim 9, wherein the receiving of the indication includes:
receiving a RAN PAGING message including the indication.

11. The method of claim 8, further comprising:
receiving, prior to transmitting the paging message, a UE capability information element from at least one of the UE, a core network (CN), or another base station; and
determining, by the CU, based on the UE capability information element, whether the UE supports determining the inactive state paging occasions using the parameter defined for determining idle state paging occasions.

12. The method of claim 8, further comprising:
transmitting, by the CU to the DU in the paging message, a configuration enabling the UE to use the parameter defined for determining the idle state paging occasions to determine the inactive state paging occasions.

13. The method of claim 8, wherein the transmitting of the paging message including the indication includes:
transmitting the paging message including an inactiveStatePODetermination indication.

14. The method of claim 8, wherein the transmitting of the paging message includes:
transmitting the paging message formatted in accordance with a protocol having termination points at the CU and the DU.

15. A network node operating as a distributed unit (DU) of a distributed base station including a central unit (CU), configured to determine paging occasions, the network node comprising:
a transceiver; and
processing hardware, configured to:
receive, from the CU, an indication as to whether a user equipment (UE) operating in an inactive state associated with a protocol for controlling radio resources supports determining inactive state paging occasions using a parameter defined for determining idle state paging occasions;
determine the inactive state paging occasions based on the indication; and
page the UE operating in the inactive state at the inactive state paging occasions.

16. The network node of claim 15, wherein:
receiving the indication includes receiving the indication indicating that the UE supports determining the inactive state paging occasions using the parameter defined for determining the idle state paging occasions; and
determining the inactive state paging occasions includes determining the inactive state paging occasions using the parameter defined for determining the idle state paging occasions.

17. The network node of claim 15, wherein:
receiving the indication includes receiving the indication indicating that the UE does not support determining the inactive state paging occasions using the parameter defined for determining the idle state paging occasions; and
determining the inactive state paging occasions includes determining the inactive state paging occasions using a parameter defined for determining inactive state paging occasions.

18. The network node of claim 15, wherein the processing hardware is further configured to:
receive, from the CU, a configuration enabling the UE to use the parameter defined for determining the idle state paging occasions to determine the inactive state paging occasions,
wherein determining the inactive state paging occasions is further based on the configuration.

19. The network node of claim 15, wherein receiving the indication includes:
receiving an inactiveStatePODetermination indication.

20. The network node of claim 15, wherein receiving the indication includes:
receiving the indication in a paging message.
